(19) United States
(12) Patent Application Publication
(10) Pub. No.: US 2012/0178357 A1
(43) Pub. Date: Jul. 12, 2012

(54) SOLAR-POWERED FAN THAT FITS INSIDE NEW AND/OR EXISTING ROOF VENTS

(76) Inventor: Dan Joseph Rheaume, Seattle, WA (US)

(21) Appl. No.: 13/345,545

(22) Filed: Jan. 6, 2012

Related U.S. Application Data
(60) Provisional application No. 61/431,171, filed on Jan. 10, 2011.

(51) Int. Cl. F24F 7/02; B23P 19/04

(52) U.S. Cl. 454/343; 29/428

(57) ABSTRACT

A solar powered fan kit for installation in a roof vent. The solar powered fan kit includes a fan attached to a fan bracket. The fan bracket is shaped to fit within a groove in the roof vent. A solar panel is attached to the vent hood to supply power to the fan. A plurality of flexible clips secure the solar panel to the vent hood.

### CROSS-REFERENCE TO RELATED APPLICATION

This application claims the benefit under 35 U.S.C. §119(e) of U.S. Provisional Patent Application No. 61/431,171 filed Jan. 10, 2011.

### BACKGROUND

1. Technical Field

The present disclosure relates to a fan for a roof vent. The present disclosure relates more particularly to a solar powered fan for a roof vent.

2. Description of the Related Art

The upper floors of buildings and homes are typically much hotter than the lower floors because heat tends to rise and make the air hotter near the top than near the bottom. In particular, the air that is at the very top of a structure, such as in the attic or on the top floor of a building, can become very hot because the air cannot rise through the roof of the structure, and therefore very hot air gets trapped at the top of the structure. With the hot air trapped at the top of the structure, costs for cooling the building can be very high.

To alleviate this problem, roof vents are installed in many roofs in order to allow hot air trapped near the top of the building to vent to the outside, thereby cooling the building. However, the flow of hot air from the top of the building through the roof vent can be very small and often depends on the amount of wind blowing across the roof of the structure. On particularly hot days where there is no breeze there can be very little air flow through the vents and therefore the air within the attic or top floor of the structure can become extremely hot and greatly increase the temperature in the structure including on the floors below. The cost of cooling the structure likewise increases. In addition to this, moist air in an attic of a home can cause damage to the home and may result in the need for a roof to be replaced.

### BRIEF SUMMARY

One embodiment is a method comprising installing a fan in a vent configured to vent air from a structure; fixing a solar panel to a vent hood coupled to the vent; and electrically coupling the solar panel to the fan to power the fan.

In one embodiment installing the fan in the vent comprises positioning a fan bracket in a groove in the vent, the fan bracket being attached to the fan. In one embodiment fixing the solar panel to the vent hood comprises coupling a flexible clip between the vent hood and the solar panel.

In one embodiment fixing the solar panel to the vent hood comprises coupling a plurality of flexible clips between the solar panel and the vent hood.

In one embodiment the method includes detaching the vent hood from the vent prior to installing the fan and reattaching the vent hood after installing the fan.

In one embodiment electrically coupling the solar panel to the fan includes coupling a wire between the fan and the solar panel.

One embodiment is a device comprising a roof vent; a groove in the roof vent; a fan bracket in the groove in the roof vent; a vent hood coupled to the roof vent; and a solar panel coupled to the roof vent and configured to supply electrical power to the fan.

In one embodiment includes a flexible clip coupled between the vent hood and the solar panel.

In one embodiment the flexible clip is configured to attach to a lip of the vent hood.

In one embodiment the fan bracket has first and second partial semicircular edges (e.g. curved edges) configured to fit in the groove.

In one embodiment the groove extends in a circle along a circumference of the roof vent.

In one embodiment a wire is coupled between the fan and the solar panel.

One embodiment is a solar powered roof vent fan kit comprising a fan configured to be installed within a roof vent; a solar panel configured to be fixed to a vent hood of the roof vent; and a wire configured to be coupled between the fan and the solar panel to supply the fan with electrical power from the solar panel when the fan is installed in the roof vent and the solar panel is fixed to the vent hood.

In one embodiment the solar powered roof vent fan kit includes a fan bracket attached to the fan, the fan bracket being shaped to fit within a groove in the roof vent to install the fan within the roof vent.

In one embodiment the fan bracket has a flat surface with partially semicircular perimeter (e.g., a curved perimeter).

In one embodiment the solar powered roof vent fan kit of claim comprises a plurality of flexible clips configured to fix the solar panel to the vent hood.

### BRIEF DESCRIPTION OF THE SEVERAL VIEWS OF THE DRAWINGS

FIG. 1 is an elevated perspective view of a solar powered vent fan according to one embodiment.

FIG. 2 is an elevated perspective view of components of a roof vent and solar powered roof vent fan according to one embodiment.

FIG. 3 illustrates components of a solar powered vent fan according to one embodiment.

FIG. 4 is a top view of a roof vent according to one embodiment.

FIG. 5A is a side view of a roof vent according to one embodiment.

FIG. 5B is a cross section of the roof vent of FIG. 5A taken along lines 5B.

FIG. 5C is an enlarged view of portion 5C of FIG. 5B.

FIG. 5D is an enlarged view of portion 5D of FIG. 5B.

### DETAILED DESCRIPTION

In the following description, numerous specific details are given to provide a thorough understanding of embodiments. The embodiments can be practiced without one or more of the specific details, or with other methods, components, materials, etc. In other instances, well-known structures, materials, or operations, such as, for example, vent hoods, fans, solar panels, etc., are not shown or described in detail to avoid obscuring aspects of the embodiments. For example, a solar panel or a fan may comprise electronic components, such as diodes, connectors, switches, controllers, etc., which are not illustrated or described in detail.

Reference throughout this specification to “one embodiment” or “an embodiment” means that a particular feature, structure, or characteristic described in connection with the embodiment is included in at least one embodiment. Thus, the appearances of the phrases “in one embodiment” “according to an embodiment” or “in an embodiment” and similar phrases in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

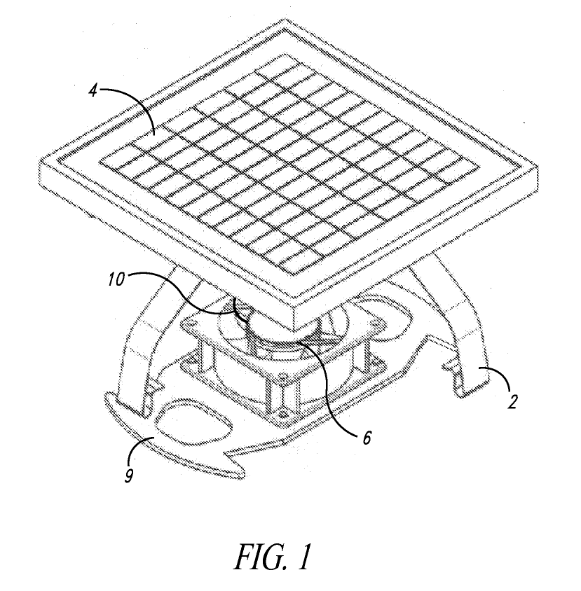

FIG. 1 is an elevated perspective view of components of a solar powered roof vent fan kit. The relative positioning of the components of the roof vent fan kit as shown in FIG. 1 is similar to how the components will be positioned when installed in a roof vent according to one embodiment, although the roof vent is not shown in FIG. 1. The solar powered roof vent fan kit includes a solar panel 4, flexible clips 2 configured to be coupled to the solar panel 4, a fan 6 coupled to a fan bracket 9, and a wire 10 coupling the fan 6 to the solar panel 4.

The solar powered roof vent fan kit of FIG. 1 is configured to be installed in a roof vent of a house or other building. In a typical roof vent installed on the roof of a structure, a vent provides a conduit between the exterior of the structure and an upper part of the interior of the structure where hot air can accumulate. A typical vent can be, for example, eight inches in diameter and of a circular cross-section. The vent typically includes a vent hood coupled to the vent and positioned above the vent to prevent debris or precipitation from above from entering the vent. The vent hood generally is positioned so that there is a space between the vent and the vent hood so that air may flow from the interior of the structure through the vent and through the exterior of the structure. The solar panel 4 is configured to be coupled to the top of the vent hood by the clips 2. The clips 2 are configured to attach to a lip portion of the vent hood so that the solar panel 4 is fixed to the top of the vent hood. The fan 6 is configured to be installed inside the vent by placing the bracket 9 to which the fan 6 is attached inside a groove within the vent. The bracket 9 may be shaped to fit tightly within the vent so that the fan 6 is fixedly installed within the vent.

The solar panel 4 collects energy from sunlight incident on the top of the solar panel 4 and converts it to electricity which is passed to the fan 6 by the wire 10. The fan 6 is thus powered entirely by electricity generated from the sun. When power is applied to the fan, the fan spins and causes air from within the structure to which the vent is attached to be expelled to the exterior of the structure, thereby cooling the structure and removing moisture therefrom.

In one embodiment, the four clips 2 are supplied in the solar powered vent fan kit. Each clip 2 is configured to attach to a respective side of a square vent hood. The clips 2 can be clips having a certain amount of flexibility. The clips 2 can be steel or stainless steel clips or any other appropriate material having an appropriate amount of flexibility to be able to bend and clip onto a vent hood and the solar panel 4. The shape of the fan bracket 9 allows it to be installed easily in a circular vent by snapping easily into a groove in a neck of the vent. The particular shapes of the components of the solar powered vent fan kit of FIG. 1 are given by way of example only. Other shapes are possible and can be selected according to the shape and design of the particular roof vent and vent hood attached to the roof vent. All such other possible configurations and shapes fall within the scope of the present disclosure.

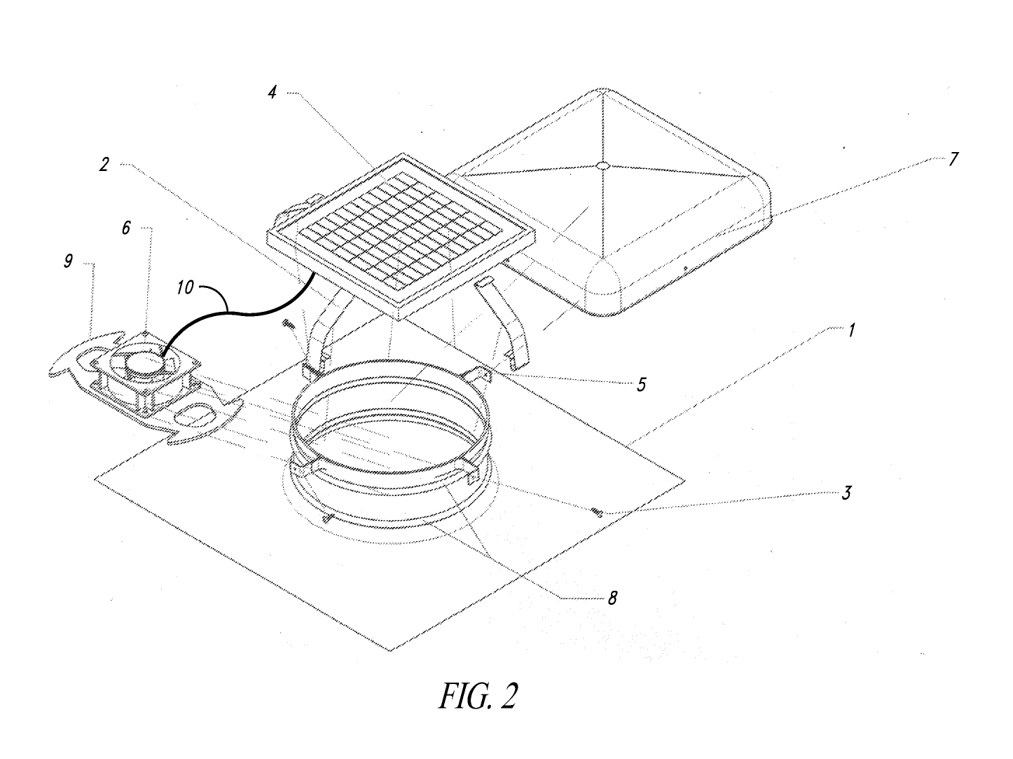

FIG. 2 is an elevated view of the components of a solar powered vent fan kit as well as a vent itself. The vent fan kit includes a solar panel 4, spring clips 2, a fan 6, and a fan bracket 9, as well as a cord 10. Also shown is a vent 1 which includes a vent base and a circular metal vent tube. The vent 1 includes grooves 8 formed in the vent 1 and extending around a circular perimeter of the vent. The vent 1 further includes vent hood brackets 5 for attaching the vent hood 7. Screws 3 can be used to fix the vent hood 7 to the vent hood brackets 5. The roof vent kit of FIG. 2 can be installed on the roof of a structure to allow air from an upper interior of the structure to pass through the exterior of the structure through the vent 1. When installing the components of the roof vent kit of FIG. 2, the vent 1 is first installed on the roof in any conventional manner. However, after installing the vent 1 in the roof, the fan 6 is installed in the vent 1 by positioning the bracket 9 in one of the grooves 8. The bracket 9 can be snapped in place in the grooves and fits tightly in the grooves 8, thereby fixing the fan 6 within the vent 1. After the fan 6 has been installed in the vent 1, the vent hood 7 is attached to the vent 1 by fixing the vent hood 7 to the vent hood brackets 5 with the screws 3. The solar panel 4 is then attached to the vent hood 7 by the spring clips 2. Each of the four spring clips is attached to a respective side of the solar panel 4 by hooking one end of each spring clip 2 onto an inner lip on an underside of the solar panel 4. The other end of each spring clip 2 is then hooked to a bottom lip of the respective sides of the hood vent 7, thereby fixing the solar panel 4 to the hood vent 7. The cord 10 may be attached to an electrical connection on the bottom side of the solar panel 4. In some embodiments, the cord 10 may be attached to an electrical connection on the fan 6 before the vent hood 7 is secured to the vent 1.

Alternatively, the solar powered fan 6 can be installed in a previously installed roof vent 1 by detaching the vent hood 7 from the vent hood brackets 5 and subsequently placing the fan bracket 9 and the attached fan 6 into the grooves 8 of the roof vent 1. The vent hood 7 can then be replaced by reattaching it to the vent hood brackets 5 and subsequently attaching the solar panel 4 to the vent hood 7. Thus, the solar powered fan kit can be installed in a previously installed vent hood or it can be jointly installed in a new installation of a vent hood 1. The solar powered fan kit can be sold with just the components shown in FIG. 1 or the solar paneled fan kit can be sold with all the components shown in FIG. 2. Of course in practice there may be other components involved in installing a roof vent 1 and a solar powered roof vent fan 6 therein. The components shown in FIG. 2 are given only by way of non-limiting example.

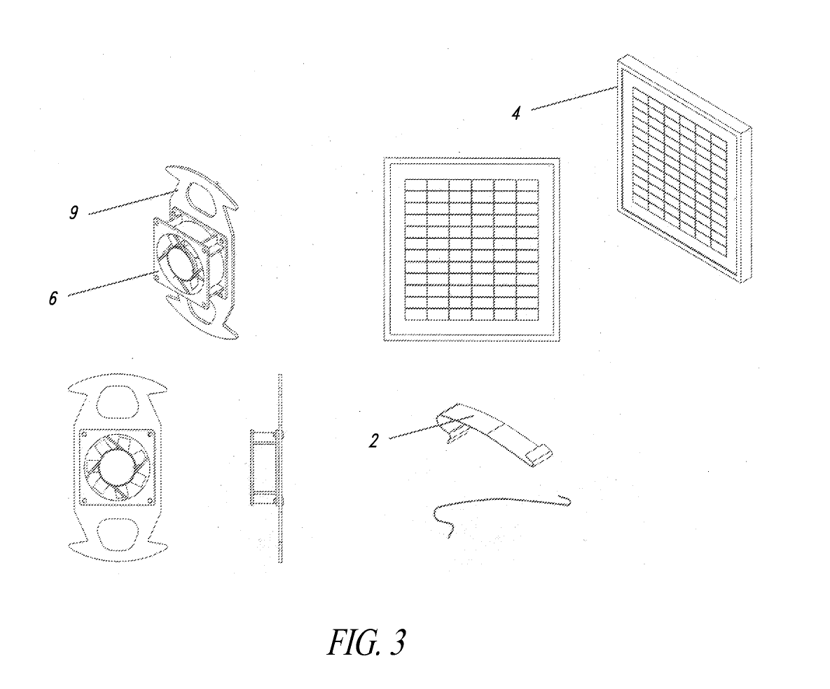

FIG. 3 illustrates embodiments of the components of the solar powered roof vent fan kit of FIG. 1 in multiple different views. The fan 6 and the bracket 9 to which the fan 6 is attached, are shown in a perspective view, in a top view, as well as from a side view. A spring clip 2 is shown from a perspective view as well as from a side view in which it appears as a thin line. The solar panel 4 is shown in a perspective view as well as in a top view.

The top view of the fan bracket 9 illustrates a flat surface having partially semicircular perimeter portions (e.g., curved edges) at two ends of the bracket 9. The partially semicircular portions of the bracket 9 allow the bracket to be placed in the groove 8 of the fan 1. The shape of the bracket 9 allows for greater air flow through the vent 1 through the holes in the bracket 9.

FIG. 4 is a top view of a roof vent 1 including a solar powered roof vent fan. Solar panel 4 is attached by spring clips 2 to a vent hood 7 as described previously. Four spring clips 2 attach the solar panel 4 to respective sides of the vent hood 7. Each spring clip 2 clips onto a lip of the vent hood 7 as well as a lip on an underside of the solar panel 4. The fan 6 is not visible in FIG. 4 because the fan is obstructed by the solar panel 4 and the vent hood 7.

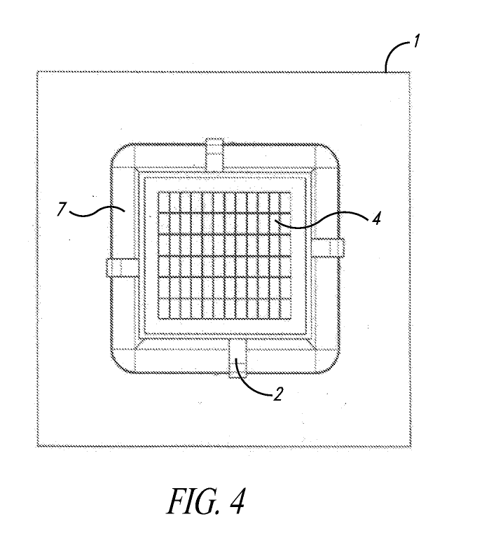

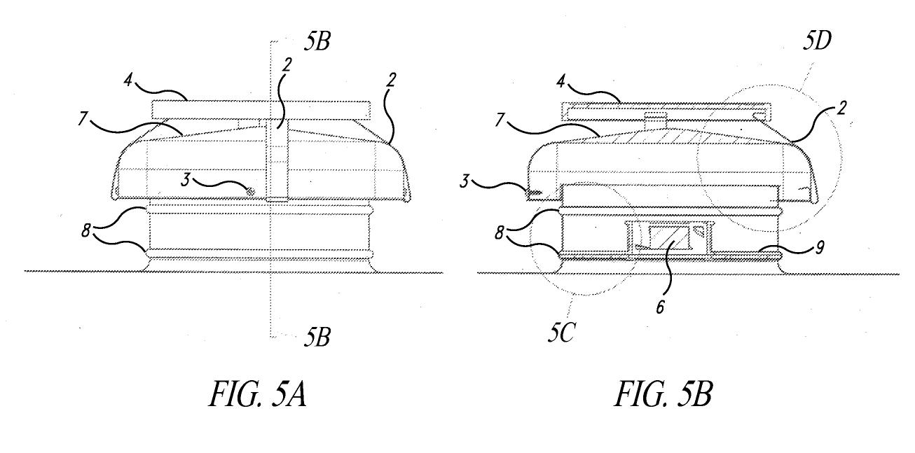

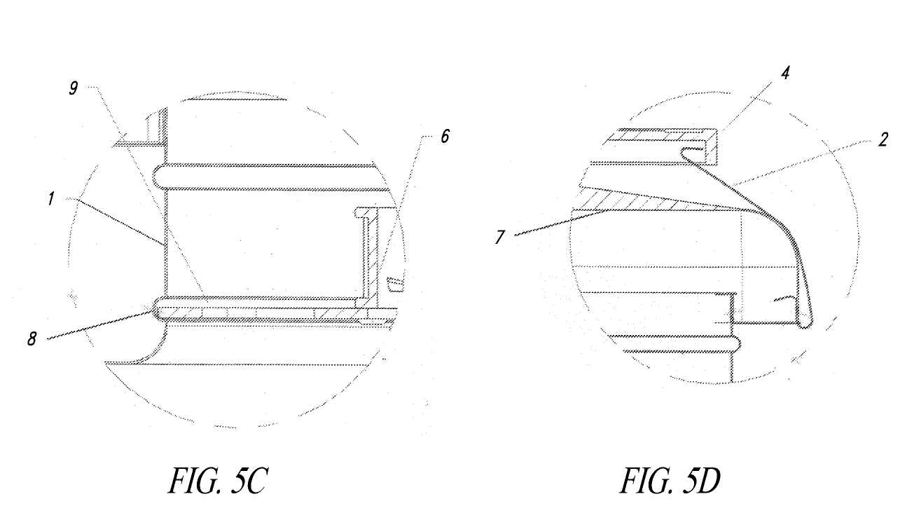

FIG. 5A is a side view of a roof vent 1. The roof vent 1 includes grooves 8 formed on a circular portion of the roof vent 1. A vent hood 7 is attached to the roof vent 1 as described previously. A screw 3 is shown which attaches the vent hood 7 to a vent hood bracket 5 not visible in FIG. 5A. Solar panel 4 is attached by clips 2 to the vent hood 7.

FIG. 5B is a cross-section of the vent 1 of FIG. 5A taken along cross-section lines 5B. In FIG. 5B, the fan 6 is visible within the vent 1. The fan 6 is attached to a bracket 9. The bracket 9 has been snapped into place in one of the grooves 8 in the vent 1 as described previously. The vent hood 7 is positioned above the vent 1. Space between the top opening of the vent 1 and the vent hood 7 allows air to flow through the vent 1 to the exterior of the vent 1. Solar panel 4 is attached to the top of the vent hood 7 by a spring clip 2. As can be seen in FIG. 5B, the spring clip 2 has a curve at one end which attaches to an inner lip on an underside of the solar panel 4. The spring clip 2 also has a hook shape at a bottom end by which it is attached to a lip of the vent hood 7. All four spring clips 2 are attached to the vent hood 7 and the solar panel 4 in this fashion though only one spring clip 2 is clearly shown in FIG. 5B. A screw 3 is shown which fixes the vent hood 7 to a vent hood bracket 5. An optional spacer (not show) may be coupled to the solar panel 4 to help position the solar panel 4 on the vent hood 7.

When sunlight is incident on the top surface of the solar panel 4, energy from the sunlight is converted to electricity which is passed by a wire 10 (not shown in FIG. 5B) to the fan 6 within the vent 1. When the fan 6 receives electricity from the solar panel 4, the fan 6 begins to rapidly rotate, for example, at a speed of around 2700 rpm. As the fan begins to rotate, air is blown from the interior of the structure through the vent 1 to the exterior of the vent 1. This helps to cool the interior of the structure which can reduce the cost of cooling the interior of the structure. This is inexpensively done because the fan 6 is powered by energy from the sun rather than by energy from a local power grid. The fan 6 also serves to expel moisture from the interior of the building which can be extremely damaging to attics or other portions of a structure. The solar powered fan 6 thereby both cools the building and expels moisture therefrom.

FIG. 5C is an enlarged view of a portion of the cross-section shown in FIG. 5B. FIG. 5C illustrates more clearly how the bracket 9 rests within the groove 8 of the vent 1. The bracket 9 fits snugly within the vent 8. The bracket 9 has a partially semicircular perimeter which matches the circular perimeter of the groove 8 of the vent 1. The bracket 9 is not formed in a complete disk but rather leaves large open areas to allow more air to flow from the interior of the structure through the vent to the exterior.

FIG. 5D is an enlarged view of a portion of the cross-section shown in FIG. 5B. In particular, FIG. 5D illustrates how the spring clip 2 attaches to a lip of the solar panel 4 at one end and to a lip of the vent hood 7 at another end. The shape of the spring clip 2 is such that it can bend somewhat as well as tightly couple the solar panel 4 to the vent hood 7. Of course the shape of the spring clip 2 can be different than shown in FIG. 5D. In particular, the shape of the spring clip 2 can be such that it will fit to a differently shaped solar panel and/or vent hood 7. Any suitable shape may be used for the vent clip 2. As illustrated, the spring clip 2 is configured to press against an outside surface of the vent hood 7 when securing the solar panel 4 to the vent hood 7, providing additional stability to the solar panel 4.

While particular structures, shapes, and components have been shown in relation to the solar powered fan kit and the vent 1, many other shapes are possible which will be apparent in light of the present disclosure. All such other shapes, materials, components, and structures fall within the scope of the present disclosure.

Some embodiments may include an optional controls, such as a thermal switch, a thermostat, one or more processors or controllers configured to control the fan and/or solar panel, etc.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device comprising:
a roof vent;
a groove in the roof vent;
a fan bracket configured to rigidly fit in the groove in the roof vent;
a vent hood configured to couple to the roof vent; and
a solar panel configured to couple to the roof vent and configured to supply electrical power to the fan.

2. The device of claim 1 comprising a flexible clip configured to couple the solar panel to the vent hood.

3. The device of claim 2 wherein the flexible clip is configured to attach to a lip of the vent hood.

4. The device of claim 1 comprising a plurality of flexible clips configured to secure the solar panel to the vent hood.

5. The device of claim 1 wherein fan bracket has first and second curved edges configured to fit in the groove.

6. The device of claim 5 wherein the groove extends in a circle along a circumference of the roof vent.

7. The device of claim 1, further comprising a wire configured to couple the fan and the solar panel.

8. A solar powered roof vent fan kit comprising:
a fan;
a fan bracket configured to rigidly couple to the fan and being shaped to fit securely within a groove in a roof vent;
a solar panel configured to be fixed to a vent hood of the roof vent; and
a wire configured to couple between the fan and the solar panel to supply the fan with electrical power from the solar panel when the fan is installed in the roof vent and the solar panel is fixed to the vent hood.

9. The solar powered roof vent fan kit of claim 8 wherein the fan bracket has a flat surface having a perimeter with one or more curved portions.

10. The solar powered roof vent fan kit of claim 8 comprising a plurality of flexible clips configured to secure the solar panel to the vent hood.

11. A method comprising:
installing a fan in a vent configured to vent air from a structure;
fixing a solar panel to a vent hood coupled to the vent; and
electrically coupling the solar panel to the fan to power the fan, wherein installing the fan in the vent comprises positioning a fan bracket in a groove in the vent, the fan bracket being attached to the fan.

12. The method of claim 11 wherein fixing the solar panel to the vent hood comprises coupling a flexible clip between the vent hood and the solar panel.

13. The method of claim 12 wherein fixing the solar panel to the vent hood comprises coupling a plurality of flexible clips between the solar panel and the vent hood.

14. The method of claim 11 comprising:
detaching the vent hood from the vent prior to installing the fan; and
reattaching the vent hood after installing the fan.

15. The method of claim 11 wherein electrically coupling the solar panel to the fan includes coupling a wire between the fan and the solar panel.
